(19) United States
(12) Patent Application Publication
(10) Pub. No.: US 2015/0220997 A1
(43) Pub. Date: Aug. 6, 2015

(54) Reputation Tiers for a Marketing Campaign

(71) Applicant: Go Daddy Operating Company, LLC, Scottsdale, AZ (US)

(72) Inventors: Neil Proctor, Cave Creek, AZ (US); Bill Brown, Phoenix, AZ (US); Ian Schiffer, San Francisco, CA (US)

(73) Assignee: Go Daddy Operating Company, LLC, Scottsdale, AZ (US)

(21) Appl. No.: 14/171,177

(22) Filed: Feb. 3, 2014

(51) Int. Cl. G06Q 30/02; G06F 17/30; G06Q 10/10; H04L 12/58

(52) U.S. Cl. CPC G06Q 30/0269; H04L 51/046; G06F 17/3089; G06Q 10/107

(57) ABSTRACT

Systems and methods of the present invention provide for one or more server computers communicatively coupled to a network and configured to: transmit a marketing campaign from a first virtual internet protocol (IP) address; identify, during a transmission of the marketing campaign, a quantity of undeliverable or unsolicited email; determine whether the quantity of undeliverable or unsolicited email is equal to or greater than a threshold quantity of undeliverable or unsolicited email; and responsive to a determination that the quantity of undeliverable or unsolicited email is equal to or greater than the threshold quantity, transmit, prior to a conclusion of the transmission, the marketing campaign from a second virtual IP address.

The subject matter of all patent applications is commonly owned and assigned to Go Daddy Operating Company, LLC. All prior applications are incorporated herein in their entirety by reference.

### FIELD OF THE INVENTION

The present inventions generally relate to the field of undeliverable email and unsolicited email and specifically to the field of detecting and mitigating undeliverable and unsolicited email.

### SUMMARY OF THE INVENTION

The present inventions provide methods and systems comprising one or more server computers communicatively coupled to a network and configured to: transmit a marketing campaign from a first virtual internet protocol (IP) address; identify, during a transmission of the marketing campaign, a quantity of undeliverable or unsolicited email; determine whether the quantity of undeliverable or unsolicited email is equal to or greater than a threshold quantity of undeliverable or unsolicited email; and responsive to a determination that the quantity of undeliverable or unsolicited email is equal to or greater than the threshold quantity, transmit, prior to a conclusion of the transmission, the marketing campaign from a second virtual IP address.

The above features and advantages of the present invention will be better understood from the following detailed description taken in conjunction with the accompanying drawings.

### BRIEF DESCRIPTION OF THE DRAWINGS

FIG. 1 is a flow diagram illustrating a possible embodiment of a method for establishing trust reputation tiers for a marketing campaign.

FIG. 2 illustrates a possible system for establishing trust reputation tiers for a marketing campaign.

FIG. 3 illustrates a more detailed possible system for establishing trust reputation tiers for a marketing campaign.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as websites. The combination of all the websites and their corresponding web pages on the Internet is generally known as the World Wide Web (WWW) or simply the Web.

Users of computer networks, such as corporate networks or the Internet, routinely send electronic messages to each other. Electronic messages may contain, for example, text, images, links, and attachments. Electronic mail or email is one of the most widely used methods of communication over the Internet due to the variety of data that may be transmitted, the large number of available recipients, speed, low cost and convenience.

The Internet provides the ability to send an email anywhere in the world, often in less than a few seconds. Delivery times are continually being reduced as the Internet's ability to transfer electronic data improves. Emails may be sent with the click of a few buttons, while letters typically need to be transported to a physical location, such as a mail box, before being sent.

There are typically few additional costs associated with sending emails. Emails thus have the extraordinary power of allowing a single user to send one or more messages to a very large number of people at an extremely low cost. However, some individuals have abused this power. Among such abuses are spam and phishing. Spam, or unsolicited email, is flooding the Internet with many copies of the identical or nearly identical message, in an attempt to force the message on people who would not otherwise choose to receive it. Most spam is commercial advertising, often for dubious products, get-rich-quick schemes, or financial or quasi-legal services.

A single spam message received by a user uses only a small amount of the user's email account's allotted disk space, requires relatively little time to delete and does little to obscure the messages desired by the user. However, the amount of spam transmitted over the Internet is growing. While a single or small number of spam messages are annoying, a large number of spam can fill a user's email account's allotted disk space thereby preventing the receipt of desired emails. Also, a large number of spam can take a significant amount of time to delete and can even obscure the presence of desired emails in the user's email account.

The volume of spam messages can cause data transmission problems for the Internet as a whole. The larger volume of data created by spam requires the Internet providers to buy larger and more powerful, i.e. more expensive, equipment to handle the additional data flow caused by the spam.

Spam has a very poor response rate compared to other forms of advertisement. However, since almost all of the costs/problems for transmitting and receiving spam are absorbed by the recipient of the spam and the providers of the Internet infrastructure, spam nevertheless continues to be commercially viable for a spammer.

In contrast to spam, a user may desire to receive updates from various marketing channels, which may keep the user apprised of a business or organization's various sales, new store openings, industry news, etc. The operators and administrators of such businesses may likewise be interested in sending such information to potential clients, subscribers and/or customers. The administrator of software for such a business may send out legitimate marketing campaigns using the software combination disclosed herein, executed on a server in a data center and displayed on a client machine to interested contacts. These administrators may also keep track of contacts they may have made using combinations of the software components described herein.

Applicant has determined that presently existing marketing campaign software provides no means to differentiate between different levels of trust for each email campaign or campaign sender. This results in campaigns that have no history or an untrustworthy history of sending undeliverable (“bounced”) or unsolicited (“spam”) email being sent using the same infrastructure (e.g., through the same IP address) as campaigns that have a more trustworthy history (e.g., where no or little bounced or spam email have been sent). Furthermore, if the IP address sending a campaign with bounced or spam emails is blocked because of its untrustworthy activities, trustworthy marketing campaigns may also be blocked and punished through no fault of their own.

Applicant has therefore determined that optimal systems and methods may improve on presently-existing systems and methods by providing means to send marketing campaigns at different levels of trust through separate instances of virtual IP addresses corresponding to various rankings of trust reputation. If, during the course of a campaign, the level of trust for a campaign sender is compromised, the campaign sender may be moved to a lower tier of trust reputation, and the campaign may be sent through an instance of a virtual IP address corresponding to that level of trust reputation. Optimal systems and methods may also include a “failover” design, where, if the lower level of trust causes the original IP address to be blocked, any campaigns being sent through that IP address may be sent through a different instance of a virtual IP address at an equal level of trust reputation.

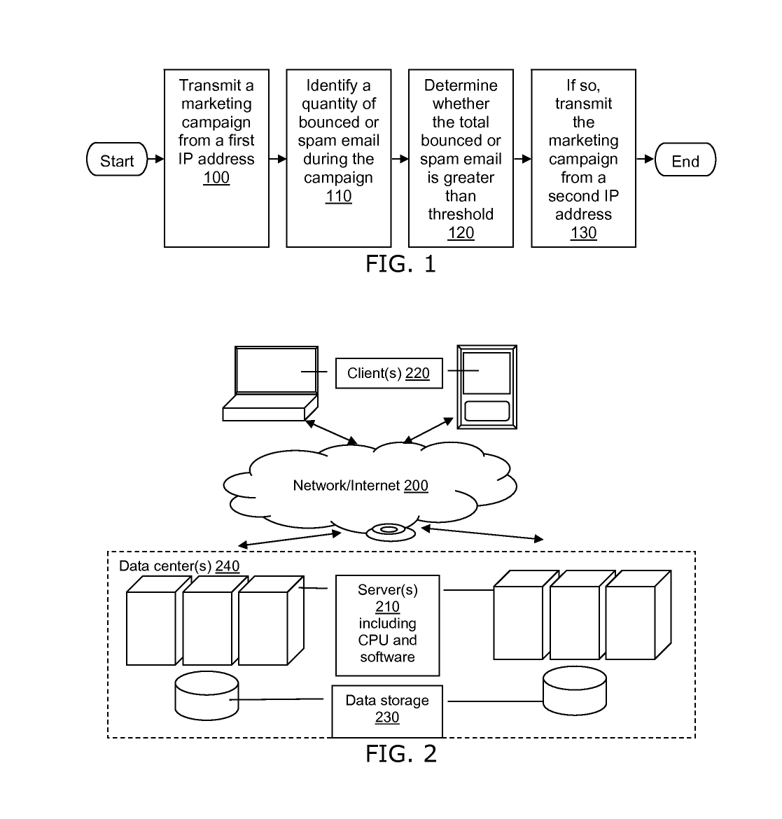

Several different methods may be used to provide and manage the disclosed inventions. In the example embodiment shown in FIG. 1, one or more server computers communicatively coupled to a network may be configured to: transmit a marketing campaign from a first virtual internet protocol (IP) address (Step 100); identify, during a transmission of the marketing campaign, a quantity of undeliverable or unsolicited email (Step 110); determine whether the quantity of undeliverable or unsolicited email is equal to or greater than a threshold quantity of undeliverable or unsolicited email (Step 120); and responsive to a determination that the quantity of undeliverable or unsolicited email is equal to or greater than the threshold quantity, transmit, prior to a conclusion of the transmission, the marketing campaign from a second virtual IP address (Step 130).

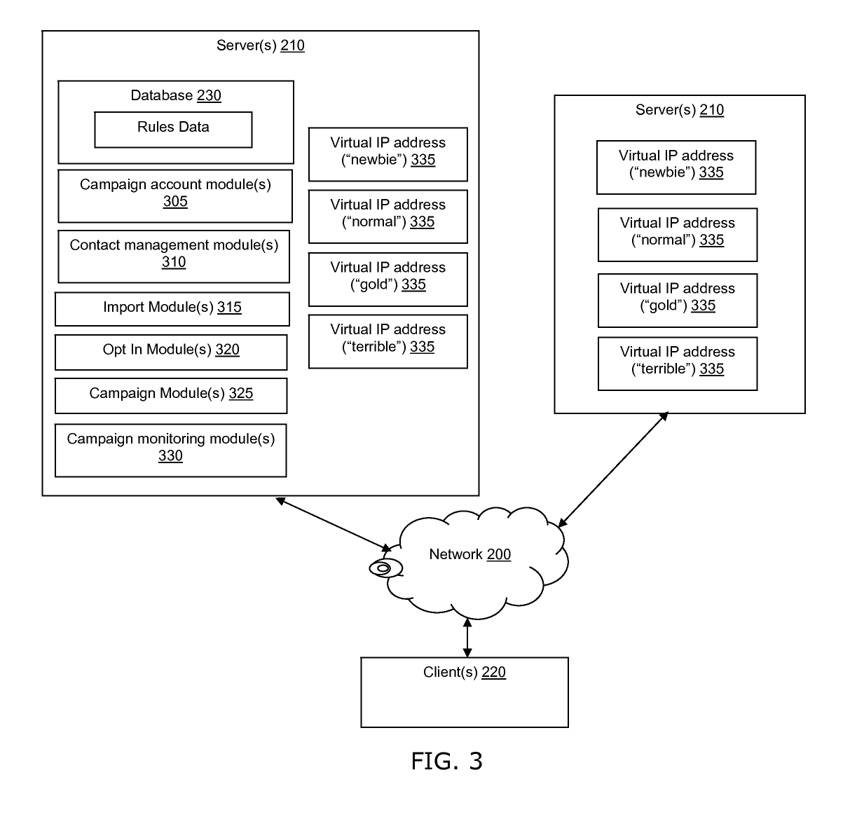

Several different environments may be used to accomplish the method steps of embodiments disclosed herein. FIG. 2 demonstrates a streamlined example and FIG. 3 demonstrates a more detailed example of an environment including a system and/or structure that may be used to accomplish the methods and embodiments disclosed and described herein. Such methods may be performed by any central processing unit (CPU) in any computing system, such as a microprocessor running on at least one server 210 and/or client 220, and executing instructions stored (perhaps as scripts and/or software, possibly as software modules/components) in computer-readable media accessible to the CPU, such as a hard disk drive on a server 210 and/or client 220.

The example embodiments shown and described herein exist within the framework of a network 200 and should not limit possible network configuration or connectivity. Such a network 200 may comprise, as non-limiting examples, any combination of the Internet, the public switched telephone network, the global Telex network, computer networks (e.g., an intranet, an extranet, a local-area network, or a wide-area network), a wired network, a wireless network, a telephone network, a corporate network backbone or any other combination of known or later developed networks.

At least one server 210 and at least one client 220 may be communicatively coupled to the network 200 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

The example embodiments herein place no limitations on whom or what may comprise users such as the campaign sender, administrator, contacts, subscribers, etc. Thus, as non-limiting examples, users may comprise any individual, entity, business, corporation, partnership, organization, governmental entity, and/or educational institution that may have occasion to organize/import contacts and/or send marketing campaigns.

Server(s) 210 may comprise any computer or program that provides services to other computers, programs, or users either in the same computer or over a computer network 200. As non-limiting examples, the server 210 may comprise application, communication, mail, database, proxy, fax, file, media, web, peer-to-peer, standalone, software, or hardware servers (i.e., server computers) and may use any server format known in the art or developed in the future (possibly a shared hosting server, a virtual dedicated hosting server, a dedicated hosting server, a cloud hosting solution, a grid hosting solution, or any combination thereof) and may be used, for example to provide access to the data needed for the software combination requested by a client 220.

The server 210 may exist within a server cluster, as illustrated. These clusters may include a group of tightly coupled computers that work together so that in many respects they can be viewed as though they are a single computer. The components may be connected to each other through fast local area networks which may improve performance and/or availability over that provided by a single computer.

The client 220 may be any computer or program that provides services to other computers, programs, or users either in the same computer or over a computer network 200. As non-limiting examples, the client 220 may be an application, communication, mail, database, proxy, fax, file, media, web, peer-to-peer, or standalone computer, cell phone, personal digital assistant (PDA), etc. which may contain an operating system, a full file system, a plurality of other necessary utilities or applications or any combination thereof on the client 220. Non limiting example programming environments for client applications may include JavaScript/AJAX (client side automation), ASP, JSP, Ruby on Rails, Python's Django, PHP, HTML pages or rich media like Flash, Flex or Silverlight.

The client(s) 220 that may be used to connect to the network 200 to accomplish the illustrated embodiments may include, but are not limited to, a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture. Client software may be used for authenticated remote access to a hosting computer or server. These may be, but are not limited to being accessed by a remote desktop program and/or a web browser, as are known in the art.

The user interface displayed on the client(s) 220 or the server(s) 210 may be any graphical, textual, scanned and/or auditory information a computer program presents to the user, and the control sequences such as keystrokes, movements of the computer mouse, selections with a touch screen, scanned information etc. used to control the program. Examples of such interfaces include any known or later developed combination of Graphical User Interfaces (GUI) or Web-based user interfaces as seen in the accompanying drawings, Touch interfaces, Conversational Interface Agents, Live User Interfaces (LUI), Command line interfaces, Non-command user interfaces, Object-oriented User Interfaces (OOUI) or Voice user interfaces. The commands received within the software combination, or any other information, may be accepted using any field, widget and/or control used in such interfaces, including but not limited to a text-box, text field, button, hyper-link, list, drop-down list, check-box, radio button, data grid, icon, graphical image, embedded link, etc.

The server 210 may be communicatively coupled to data storage 230 of contact information, email distribution information, abuse information, import information, opt-in information, bounced email information, or any other information requested or required by the system and/or described herein. The data storage 230 may be any computer components, devices, and/or recording media that may retain digital data used for computing for some interval of time. The storage may be capable of retaining stored content for any data required, on a single machine or in a cluster of computers over the network 200, in separate memory areas of the same machine such as different hard drives, or in separate partitions within the same hard drive, such as a database partition.

Non-limiting examples of the data storage 230 may include, but are not limited to, a Network Area Storage, (“NAS”), which may be a self-contained file level computer data storage connected to and supplying a computer network with file-based data storage services. The storage subsystem may also be a Storage Area Network (“SAN”—an architecture to attach remote computer storage devices to servers in such a way that the devices appear as locally attached), an NAS-SAN hybrid, any other means of central/shared storage now known or later developed or any combination thereof.

Structurally, the data storage 230 may comprise any collection of data. As non-limiting examples, the data storage 230 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage such as a magnetic media, hard drive, other disk drive, volatile memory (e.g., RAM), non-volatile memory (e.g., ROM or flash), and/or any combination thereof.

The server(s) 210 or software modules within the server(s) 210 may use query languages such as MSSQL or MySQL to retrieve the content from the data storage 230. Server-side scripting languages such as ASP, PHP, CGI/Perl, proprietary scripting software/modules/components etc. may be used to process the retrieved data. The retrieved data may be analyzed in order to determine the actions to be taken by the scripting language, including executing any method steps disclosed herein.

The software modules/components of the software combination used in the context of the current invention may be stored in the memory of—and run on—at least one server 210. As non-limiting examples of such software, the paragraphs below describe in detail the software modules/components that make up the software combination. These software modules/components may comprise software and/or scripts containing instructions that, when executed by a microprocessor on a server 210 or client 220, cause the microprocessor to accomplish the purpose of the module/component as described in detail herein. The software combination may also share information, including data from data sources and/or variables used in various algorithms executed on the servers 210 and/or clients 220 within the system, between each module/component of the software combination as needed.

A data center 240 may provide hosting services for the software combination, or any related hosted website including, but not limited to hosting one or more computers or servers in a data center 240 as well as providing the general infrastructure necessary to offer hosting services to Internet users including hardware, software, Internet web sites, hosting servers, and electronic communication means necessary to connect multiple computers and/or servers to the Internet or any other network 200.

FIG. 3 shows a more detailed example embodiment of an environment for accomplishing the systems and method steps disclosed herein. As non-limiting examples, all disclosed software modules, may run on one or more server(s) 210 and may include one or more user interfaces generated by the server(s) 210 and transmitted to and displayed on the client(s) 220. The user interface(s) may be configured to receive input from the user and transmit this input to the server(s) 210 for the administration of the software and data in data storage 230 associated with the software modules.

The campaign account module(s) 305 may be configured for administration of one or more accounts associated with a “campaign sender” (e.g., a system user, an account administrator, a business owner, a website administrator, any account manager or any other user or administrator sending any type of marketing campaign). The campaign account module(s) 305 may work in conjunction with the contact management software module(s) 310, import software module(s) 315, opt in software module(s) 320, campaign software module(s) 325, campaign monitoring software module(s) 330 and/or any other software modules described herein (e.g., to identify and associate one or more contacts, opted in contacts and/or marketing campaigns with a campaign sender identified in data storage 230).

The software modules described herein may work in conjunction with data storage 230 to store data, as a non-limiting example, for one or more campaign sender accounts (e.g., username, password, user/business ID, etc.), one or more contacts (e.g., email addresses and related information), one or more marketing campaigns (e.g., email distributions), one or more campaign or other rules (e.g., thresholds of undeliverable or unsolicited email causing the system to take action), one or more available instances of virtual internet protocol (“IP”) addresses 335 running on the server(s) 210, and one or more “tiers” representing a trust reputation level for each campaign sender, and further used to determine the virtual instance of an internet protocol (IP) address 335 associated with a particular tier, etc.

The data may be organized according to any data structure known in the art. This structured data may be associated with other stored and structured data within the data storage 230. As a non-limiting example, the disclosed system may be configured to create one or more data tables for a grouping of data, such as those listed above, within data storage 230. Each of these data tables may contain one or more data records, each of the data records comprising one or more data fields, including a unique identifier for the record and additional details about the record.

As a non-limiting example, a campaign sender account may be created, as described above, and assigned a unique identifier (“user ID,” “business ID,” “campaign sender ID” etc.). Data fields within a data record associated with the user/business account may be populated with additional campaign sender account data. This additional campaign sender account data may include additional details about the campaign sender account, such as a user or business name, username, password, physical address, email address, phone number etc.

FIG. 3 also shows that the server(s) 220 may host and/or run one or more contact management software module(s) 310 for storing and managing one or more contacts, including one or more email addresses for each contact. The contact module(s) 310 may work in conjunction with the campaign sender account module(s) 305, import module(s) 315, opt in module(s) 320, campaign module(s) 325 and/or campaign monitoring module(s) 330 described herein (e.g., to track and analyze one or more contacts associated with one or more campaigns, and/or their status as opted in contacts, having been identified as undeliverable or unsolicited email, etc.).

The contact data may be stored in data storage 230, may be tracked by the software disclosed herein and may comprise, as non-limiting examples: one or more contacts, such as an email address; an indicator of whether or not the contact is managed by contact module(s) 310; an indicator of whether or not the contact has been imported, possibly by the disclosed import module(s) 315, into one or more marketing campaigns such as an email distribution; an indicator of whether or not the contact has been opted in to the marketing campaign, possibly via opt-in module(s) 320; and an indicator of whether or not the contact has been identified, during the marketing campaign, as being undeliverable (“bounced”), or as an unsolicited contact (“spam”), email etc. Each record may further indicate the campaign sender account associated with the contact record and/or any associated campaign.

One or more import software modules 315 may run within, or independently of, the contact module(s) 310. The import software module(s) 315 may be configured to import one or more contact lists into the contact management software module(s) 310. These contact lists may include email addresses and/or any additional contact information for one or more contacts. The contact information from these contact lists may be stored in data storage 230 as described herein and administrated, possibly using a contact module(s) 310 interface displayed on the client computer(s) 220.

FIG. 3 also shows that the server(s) 210 may host and/or run one or more opt-in software modules 320. The opt-in module(s) 320 may work in conjunction with the campaign sender account module(s) 305, contact module(s) 310, import module(s) 315, campaign module(s) 325 and/or campaign monitoring module(s) 330 described herein (e.g., opting in the contacts associated with one or more campaigns, the campaign(s) being associated with a campaign sender). The opt-in module(s) 320 may analyze each contact stored in data storage 230 to determine whether the contact is opted in to one or more marketing campaigns, such as an email distribution. The contact may have been opted into the campaign by the campaign sender opting the contact into the campaign, causing a greater risk that the contact will bounce or is spam, or the contact may opt in to the campaign.

As non-limiting examples, the contact may opt in via a signup form on the campaign sender's web page for future campaigns, or the campaign sender may send a “permission email” (possibly using the campaign module(s) 325, described herein) to each of the contacts in a contact list This permission email may allow the contact to opt in to future campaigns. It should be noted that any functionality described herein for campaigns may also apply to these types of permission emails.

The contact may have a status of “opted-out” if the contact's email address is found in the database of known bounced emails, or is identified as spam, during import or campaign transmission. If contacts have a status of “opted out,” those contacts may not be included in future campaigns.

One or more campaign software modules 325, also shown in FIG. 3, may be configured to manage the contacts when sending a marketing campaign such as an email distribution, or permission emails. The campaign module(s) 325 may work in conjunction with the campaign account module(s) 305, contact module(s) 310, import module(s) 315, opt in module(s) 320, and/or campaign monitoring module(s) 330 described herein (e.g., determining the opted in contacts associated with one or more campaigns, the campaign(s) being associated with a user or business ID for a campaign account).

The campaign module(s) 325 may be configured to prepare a marketing campaign such as an email distribution by receiving a message content and a distribution schedule from the campaign sender, transmitting the marketing campaign, receiving feedback from the campaign monitoring module(s) 330, processing bounced or spam email and taking actions based on the feedback received, as described herein. The campaign module(s) 325 may be further configured to manage the email distribution, generate reports and update settings for the campaign.

The system may track one or more campaigns, each of the one or more campaigns being associated with a campaign sender account. Data storage 230 may also store data about the one or more campaigns, such as the campaign size, administrative settings, included content, bounced or spam email results, etc., and store the data for each campaign in association with the one or more campaign sender accounts. This data may also be associated in the database with one or more contacts, possibly identified in data storage as opted in to receive communications from the campaign.

The database may further store a collection of rules data. These rules may be referenced by any of the software modules disclosed herein to mitigate possible abuse of the system, such as using system resources to attempt to send emails within a marketing campaign to one or more email addresses identified in the database as undeliverable or having requested no further contact via the marketing campaign.

As non-limiting examples, the rules may instruct the software modules, prior to sending a campaign, to cross reference the email addresses opted into the campaign with any email addresses that have been identified as being undeliverable in previous email distributions, or having requested no further email distributions (e.g., having opted out after identifying the attempted email distribution as bounced or spam). If the total email addresses identified with the undeliverable or unsolicited email is greater than a threshold stored within the stored rules, the stored rules may instruct the software modules to accomplish some action, such as not sending the campaign, pausing the marketing campaign or re-distributing the email distribution through an instance of a virtual IP address 335 associated with a lower tier, as described herein. These rules may further monitor each campaign and determine if the bounced or spam email identified within the email distribution exceeds the thresholds defined in the rules

After creating a user account, establishing a contact list (possibly by importing and/or opting in contacts) and creating a campaign (such as an email marketing campaign), a campaign sender may send a campaign, possibly via the campaign module(s) 325.

During an initial campaign or subsequent campaigns, a campaign monitoring module(s) 330 may be configured to execute a “sending and feedback loop,” so that as each email is sent, the campaign monitoring module(s) 330 may sense feedback from each sent email, such as whether the email bounced or was identified as spam, etc. In some embodiments, the campaign monitoring module(s) 330 may comprise third party software such as Power MTA or open source solutions such as QMail.

The feedback received by the campaign monitoring module(s) 330 may be used to identify “abuse” of the system (e.g., bounced or spam emails) where the campaign sender may have intentionally or unintentionally opted in campaign recipients from a bad contact list. The campaign monitoring module(s) 335 may transmit the feedback to the campaign module(s) 325 and the campaign module(s) 325, or any other disclosed software, may then analyze the feedback to make intelligent decisions, as described herein, regarding whether the campaign sender should be moved to a different trust reputation tier, be sent from a different virtual IP address 335, have the current campaign paused, send education materials to the admin for “scrubbing” the opt-in list, etc.

As a non-limiting example, as the email is received from a customer of the campaign sender, the customer may click a link or button within the email identifying the email as spam. This input may be transmitted to the campaign monitoring module(s) 330, which may then identify the address associated with the unsolicited email, add it to a possible total count, and transmit it to the campaign module(s) 325 for processing, as described herein.

The campaign monitoring module(s) 330 may further be configured to determine whether an instance of a virtual IP address 335 used to send the campaign has been blocked. As described herein, the disclosed combination of software may then send the offending campaign from an instance of a virtual IP address 335 associated with a lower trust reputation tier and move any additional email campaigns currently sending from the blocked IP address 335 to a failover instance of a virtual IP address 335 running on the same or another server 210.

During or at the conclusion of the initial and any subsequent campaigns, the campaign module(s) 325 may analyze and process the data received from the campaign monitoring module(s) 335. This processing may include logging any instances of abuse in data storage 230 to later determine a trust reputation tier for the campaign sender, discussed herein, and whether to send subsequent campaigns associated with that campaign sender. In other words, as more campaigns are completed and the campaign module(s) 325 are given access to more data about the campaign sender, the system may process this data and determine that the account falls into one or more tiers for typical, high or low amounts of abuse.

The trust reputation tier may represent a rank of the quality reputation for campaigns associated with a campaign sender. The trust reputation tier may be based on a total of undeliverable or unsolicited email identified in a current or most recent campaign and/or a total or average of the number of undeliverable or unsolicited emails identified throughout a campaign sender's campaign history.

To determine the tier assigned to the campaign sender after the first or subsequent campaigns, the campaign module(s) 325 may access the rules data, including the trust reputation tier rules, stored in the database. These trust reputation tier rules may store a threshold amount of undeliverable or unsolicited email, each threshold amount being assigned to one of multiple tiers. The threshold amount may be assigned by an account administrator or determined algorithmically within the system. In short, each level of trust may be based on a long standing relationship with the campaign sender and/or the level of reported instances of abuse.

The campaign module(s) 325 may be configured to determine the total number of undeliverable and/or unsolicited emails, either from the current/most recent campaign, or as a total or an average of all campaigns. The campaign module(s) 325 may then compare this total with the threshold amount defined for each trust reputation tier and assign the campaign sender account the trust reputation tier appropriate to the amount of abuse identified within the campaign(s). The campaign module(s) 325 may store the trust reputation tier assigned to the campaign sender in data storage 230.

As a non-limiting example, the trust reputation tier rules may include a “newbie” tier (for new campaigns as described above), a “gold” tier, a “normal” tier and a “terrible” tier. For purposes of this non-limiting example, the gold tier may represent the tier with the highest level of trust, in which users have sent several campaigns and in which the results demonstrated no or very few instances of alerts raised due to abuse (blocked IP addresses, bounced/spam emails, etc.). The normal tier may represent the tier below the highest level of trust, where the amount of alerts raised due to abuse is within a range higher than the gold tier, but less than the terrible tier. The terrible tier may represent significant reports of abuse, where the campaign sender has continuously opted in contacts where the campaign email either bounced or was reported as spam, and/or where the IP address 335 through which the campaign was sent was ultimately blocked.

The tiers are significant, in that tiers with a higher reputation or rank have a threshold allowing greater amounts of email to be sent simultaneously during the campaign than tiers having a lower reputation or rank. In other words, using the example above, the campaign module(s) 325 may send a campaign for a campaign sender with a gold tier reputation all at once, while a campaign sent for a campaign sender with a terrible tier reputation may require that emails be sent in batches and intervals, so that the emails sent in each batch may be tested to determine if the email bounces or is identified as spam.

Each campaign may be sent from a specific IP address. The system disclosed herein may include one or more instances of virtual IP addresses 335 configured to run on the server(s) 210. These instances of virtual IP addresses 335 may be any IP address assigned to multiple applications residing on server(s) 210 rather than being assigned to a specific single server or network interface card. Each instance of the virtual IP addresses 335 may run separately from the others so that a lower reputation tier associated with one instance of the virtual IP address does not damage other campaigns being sent from an instance of a virtual IP address 335 associated with a higher reputation tier (e.g., by being blocked).

Data storage 230 may store a list of instances of virtual IP addresses 335, possibly as part of the rules data, and each of these instances of virtual IP addresses 335 may be further associated with trust reputation tier data. The tier assigned to each campaign sender may then be cross referenced with an appropriate instance of an IP address 335 associated with that tier. The selected IP address 335 may then be used to send the prepared campaign.

Continuing the non-limiting example above, the system may include multiple physical servers, each running four instances of virtual IP addresses 335, each of the instances of virtual IP addresses 335 being associated in data storage 230 with each of the four trust reputation tiers from the example above. Namely, a the newbie tier may be associated in the database with the instance of virtual IP address 123.456.7 running on server(s) 230, the gold tier may be associated with the instance of virtual IP address 234.567.8, the normal tier may be associated with the instance of virtual IP address 345.678.9 and the terrible tier may be associated with the instance of virtual IP address 456.789.0.

Prior to launching a campaign, the disclosed combination of software may be configured to determine one of one or more instances of a virtual IP addresses 335 through which the campaign will be transmitted. The IP address 335 through which the campaign is transmitted may be determined according to the trust reputation tier associated in the database with the campaign sender.

As a non-limiting example, when a new campaign is created for a new campaign sender, no campaign data exists to determine an appropriate trust reputation tier. The first campaign sent from this campaign sender may be sent through the instance of virtual IP address 123.456.7. The campaign sender may be assigned to the normal tier in subsequent campaigns based on the performance of the first and subsequent email distributions. Prior to the campaign sender sending any future campaigns, the appropriate data within data storage 230 may be queried and the campaign may be sent through the instance of virtual IP address 234.567.8, associated in data storage 230 with the normal tier.

Prior to each campaign sent by a campaign sender, the campaign module(s) 325 may be configured to query data storage 230 to identify any previous instances of system abuse. The campaign module(s) 325 may determine if each email address in the campaign is found in data stored in data storage 230 of known undeliverable email addresses, has identified the campaign sender as sending unsolicited email, has had their IP address blocked, is found on a blacklist, etc.

Any instances of abuse may be totaled and compared with the rules data to determine if the total instances of abuse are greater than a threshold amount allowed by the rules data to send the campaign. Prior to sending the campaign, the campaign module(s) 325 may identify the campaign sender, determine the trust reputation tier for the campaign sender, and send the campaign through an instance of the virtual IP address 335 associated with that trust reputation tier. The campaign sender may then prepare and send the campaign to the email addresses opted in for that campaign.

As with an initial campaign, the campaign monitoring module(s) 330 may process emails identified as undeliverable or unsolicited, store this information in data storage 230 and transmit the feedback to the campaign module(s) 325, or any other disclosed software. The campaign module(s) 325 may be configured, during continued transmission of the campaign, to keep a running total of instances of abuse.

As the transmission of the campaign continues, the campaign module(s) 325, or any other disclosed software, may use the feedback data and the trust reputation tier associated with the campaign sender to query data storage 230 to determine the stored threshold for the appropriate trust reputation tier.

The campaign module(s) 325, or any other disclosed software, may then compare the running total of instances of bounced or spam email with the established threshold for the appropriate trust reputation tier in order to determine if the running total of instances of abuse exceeds the established threshold, and thereby determine whether or not to take action, such as assigning a new tier to the campaign sender, sending the campaign through an appropriate instance of a virtual IP address 335 associated with the newly assigned tier and/or pausing a campaign to educate the campaign sender in techniques to improve their contact/opt-in list as described herein.

If the running total of instances of abuse does not exceed the established threshold, the steps for sending the campaign and determining if the running total of instances of abuse exceeds the established threshold may be repeated until either the campaign completes, or the running total of instances of abuse exceeds the established threshold.

If the running total of instances of abuse equals or exceeds the established threshold, the comparison may be used as a validation point to trigger certain actions. As a non-limiting example, the campaign module(s) 325, or other disclosed software, may re-assign the tier associated with the campaign sender “on the fly,” (i.e. during the campaign distribution) to avoid interfering with and/or damaging campaigns being sent through the same instance of the virtual IP address 335.

To accomplish this, as a non-limiting example, the campaign module(s) 325 may be configured to search data storage 230, possibly the rules and/or reputation tier data, to determine the current trust reputation tier for the campaign sender, as well as the trust reputation tier immediately below. The campaign module may then be configured to update data storage 230 to reflect that the campaign sender is now associated with the trust reputation tier immediately below the previous one.

In addition, if the running total of instances of abuse equals or exceeds the established threshold, the campaign module(s) 325 may be configured, during the campaign, to send the campaign through a different instance of a virtual IP address 335 associated with the trust reputation tier immediately below the previous one.

To accomplish this, if the running total of instances of abuse equals or exceeds the established threshold, the campaign module(s) 325 or any other disclosed software, may be configured, during the campaign, to query data storage 230 to determine the instance of the virtual IP address 335 through which the campaign is currently being sent.

After updating data storage 230 to reflect the new trust reputation tier associated with the campaign sender, the campaign module(s) 325, or any other disclosed software, may be configured to then query data storage 230 to identify an instance of a virtual IP address 335 associated with the new trust reputation tier, which is associated with the campaign sender. The campaign module(s) 325, or any other disclosed software, may be configured to then update data storage 230 to reflect the association with this new instance of the virtual IP address 335. The remainder of the campaign may then be sent through the instance of the virtual IP address 335 associated with the new trust reputation tier for the campaign sender.

The software combination may then continue this sending, testing and feedback loop until either the email distribution is complete, or until the email distribution has been moved to the lowest possible tier and exceeded the threshold amount of abuse email for the lowest possible tier.

As previously noted, the campaign monitoring module(s) 330, or other disclosed software, may be configured to monitor the campaign, as well as the instance of the virtual IP address 335, to determine if the instances of bounced or spam email have caused the instance of the virtual IP address 335 to be blocked from further campaign transmissions. To determine if the instance of the virtual IP address has been blocked, the campaign monitoring module(s) 330, or other disclosed software, may work in conjunction with one or more IP monitoring services and/or software to identify blocked instances of virtual IP addresses 335 running on the server(s) 210.

As non-limiting examples, IP blacklists (e.g., anti spam databases) may be used to identify IP addresses that may be transmitting the offending campaign. Likewise, Proofpoint and Centerscore are two IP address lookup services which monitor IP addresses for campaigns, score abuse, rank the IP addresses, and/or document blocked IP addresses.

If the IP address 335 for the offending campaign is blocked, all other campaigns being sent through that instance of the virtual IP address 335 may be transferred to one or more “failover” instances of virtual IP addresses 335. To accomplish this, the campaign module(s) 325, or other disclosed software, may be configured to confirm that the instance of the virtual IP address 335 has been blocked, as described above. On confirmation that the IP address 335 has been blocked, the campaign module(s) 325, or other disclosed software, may query data storage 230 to determine the trust reputation level of the blocked instance of the virtual IP address 335.

After identifying the trust reputation tier for these campaigns, the campaign module(s) 325, or other disclosed software, may be configured to query data storage 230 to identify one or more other instances of a virtual IP address 335 associated with the identified trust reputation tier. In some embodiments, this “failover” instance of the virtual IP address 335 may be located and running on another server. The campaign module(s) 325, or other disclosed software, may then be configured to transmit the remaining portion of the identified campaigns through the identified failover instance of the virtual IP address 335.

The campaign module(s) 325, or other disclosed software, may continue sending the campaign, checking to determine if the threshold has been met or exceeded, checking to see if the IP address 335 has been blocked, updating data storage 230 to reflect associations with new trust reputation tiers and/or instances of virtual IP addresses 335 (moving additional campaigns to a failover server as necessary) and sending the campaign through the updated instance of the virtual IP address 335 until either the campaign runs to completion, or the campaign equals or exceeds the running total instances of abuse for the lowest trust reputation tier. As a non-limiting example, the campaign sender may have attempted to send a campaign for a purchased a bad list of contacts without confirming that the email addresses are valid or that all opted in contacts want to receive the campaign.

If the running total of instances of abuse for a campaign equals or exceeds the established threshold for the lowest possible trust reputation tier, the campaign module(s) 325, or other disclosed software, may be configured to “pause” the campaign, delaying delivery of the campaign temporarily. An email may be sent to the contact for the campaign sender, alerting them to the delayed delivery, and possibly including a link to educational materials for best practices for campaigns and improving contact lists.

As non-limiting examples, the educational materials for best practices for campaigns and improving contact lists may include websites or other documentation for best practices on importing, opting in and/or delivering email campaigns. These best practices may include deleting lists resulting in a “paused campaign,” deleting these lists during import if the amount of identified spam or bounced email equals or exceeds the threshold amount from the rules data, manually reviewing the contacts list to identify contacts the campaign sender does not recognize, deleting unverified contacts, manually “grooming” the list to delete unfamiliar or unidentified contacts, sending out opt-in confirmation emails to confirm unknown contacts, etc.

The campaign software 325 may then be configured to determine that the campaign sender for a deferred campaign has “scrubbed” their contact lists according to the recommendations from the educational materials. The campaign may then resume. In some embodiments, the campaign sender may be sent a confirmation that they have completed all needed steps to begin sending the campaign again. In other embodiments, the campaign sender may use their own judgment to determine if the campaign is ready to begin sending again.

The campaign module(s) 325, or other disclosed software, may be configured to send the first campaign, subsequent campaigns, permission emails and/or other email correspondence from the lowest tier in staggered “batches” with a time delay. Thus, rather than send out the entire email distribution at once and risk a high volume of undeliverable emails or emails reported as unsolicited emails, the campaign component 325 may send the campaign over a specified interval in batches. However, email addresses which are not in the bounced address database, are not undeliverable or unsolicited and/or in an abuse database may be sent all at once.

In some embodiments, this may occur as the campaign sender resumes the campaign after “scrubbing” their contact list for opted in contacts. The batches and time delays may be defined as part of the rules data. The campaign module(s) 325, or other disclosed software, may then stagger the campaign. In some embodiments, the campaign may include first time campaigns, permission emails, or any other email distributions.

The methods and details for these batches and the time delay should not be limited and may be accomplished in various ways. As a non-limiting example, the rules may define a staggered and delayed schedule where 10 emails are sent. The system may delay any further activity for the campaign for 5 minutes. The feedback from these emails may be received, and if no abuse problems are found (e.g., no bounced or spam emails are identified) another 10 or 20 emails may be transmitted, activity may be delayed and feedback may be received. This pattern may continue according to the instructions stored in the rules data.

The steps included in the embodiments illustrated and described in relation to FIGS. 1-3 are not limited to the embodiment shown in FIGS. 1 and 3 and may be combined in several different orders and modified within multiple other embodiments. Although disclosed in specific combinations within these figures, the steps disclosed may be independent, arranged and combined in any order and/or dependent on any other steps or combinations of steps.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method, comprising the steps of:
a) transmitting, by a server computer communicatively coupled to a network, a marketing campaign from a first internet protocol address;
b) identifying, by the server computer, during a transmission of the marketing campaign, a quantity of undeliverable or unsolicited email;
c) determining, by the server computer, whether the quantity of undeliverable or unsolicited email is equal to or greater than a threshold quantity of undeliverable or unsolicited email; and
d) responsive to a determination that the quantity of undeliverable or unsolicited email is at least equal the threshold quantity, transmitting, by the server computer, prior to a conclusion of the transmission, the marketing campaign from a second internet protocol address.

2. The method of claim 1, further comprising the steps of
i) receiving, by at least one campaign monitoring module running on the server computer, at least one notice of at least one email within the marketing campaign identified as undeliverable or unsolicited; and
ii) determining, by the server computer, the quantity of undeliverable or unsolicited email from the at least one notice.

3. The method of claim 1, further comprising the step of storing, by the server computer, in a database communicatively coupled to the network, a rule comprising the threshold quantity of undeliverable or unsolicited email.

4. The method of claim 3, wherein the threshold quantity and the rule define at least one trust reputation tier.

5. The method of claim 4, further comprising at least one additional rule defining:
i) at least one higher trust reputation tier comprising a lower threshold quantity of undeliverable or unsolicited email; or
ii) at least one lower trust reputation tier comprising a higher threshold quantity of undeliverable or unsolicited email.

6. The method of claim 5, further comprising the step of storing, by the server computer, in the database:
i) at least one campaign account;
ii) at least one contact;
iii) an indication of whether said at least one contact is opted in to said marketing campaign;
iv) the at least one rule defining the trust reputation tier; and
v) the at least one additional rule defining the at least one higher trust reputation tier and the at least one lower trust reputation tier;

7. The method of claim 5, wherein:
i) the first internet protocol address is a first instance of a virtual internet protocol address running on the server; and
ii) the second internet protocol address is a second instance of a virtual internet protocol address associated in the database with the at least one lower trust reputation tier

8. The method of claim 5, further comprising the steps of:
i) determining whether the quantity of undeliverable or unsolicited email is at least equal to a highest threshold quantity for the at least one lower trust reputation tier; and
ii) responsive to a determination that the quantity of undeliverable or unsolicited email is at least equal to the highest threshold quantity, deferring, by the server computer, transmission of the marketing campaign.

9. The method of claim 1, further comprising the steps of:
i) determining, by the server computer, whether the first internet protocol address has been blocked from transmitting the marketing campaign; and
ii) responsive to a determination that the first internet protocol address has been blocked:
a) transmitting, by the server computer, the marketing campaign from the second internet protocol address;
b) identifying, by the server computer, at least one additional marketing campaign being sent from the first internet protocol address; and
c) transmitting, by the server computer, the at least one additional marketing campaign from a third internet protocol address.

10. A system, comprising a server computer communicatively coupled to a network and configured to:
a) transmit a marketing campaign from a first internet protocol address;
b) identify, during a transmission of the marketing campaign, a quantity of undeliverable or unsolicited email;
c) determine whether the quantity of undeliverable or unsolicited email is equal to or greater than a threshold quantity of undeliverable or unsolicited email; and
d) responsive to a determination that the quantity of undeliverable or unsolicited email is at least equal the threshold quantity, transmit, prior to a conclusion of the transmission, the marketing campaign from a second internet protocol address.

11. The system of claim 10, wherein the quantity of undeliverable or unsolicited email is identified by a software comprising at least one campaign monitoring module configured to receive notice of at least one email within the marketing campaign as being undeliverable or unsolicited.

12. The system of claim 11, wherein the software further comprises:
i) at least one campaign account module;
ii) at least one contact management module;
iii) at least one opt in module; and
iv) at least one campaign module configured to:
a) administer the marketing campaign; and
b) perform determining step C) and transmitting step D).

13. The system of claim 10, further comprising a database communicatively coupled to the network and configured to store a rule comprising the threshold quantity of undeliverable or unsolicited email.

14. The system of claim 13, wherein the threshold quantity and the rule define at least one trust reputation tier.

15. The system of claim 14, further comprising at least one additional rule defining:
i) at least one higher trust reputation tier comprising a lower threshold quantity of undeliverable or unsolicited email; or
ii) at least one lower trust reputation tier comprising a higher threshold quantity of undeliverable or unsolicited email.

16. The system of claim 15, wherein the database is further configured to store:
i) at least one campaign account;
ii) at least one contact;
iii) an indication of whether said at least one contact is opted in to said marketing campaign;
iv) the at least one rule defining the trust reputation tier; and
v) the at least one additional rule defining the at least one higher trust reputation tier and the at least one lower trust reputation tier;

17. The system of claim 15, wherein:
i) the first internet protocol address is a first instance of a virtual internet protocol address running on the server; and
ii) the second internet protocol address is a second instance of a virtual internet protocol address associated in the database with the at least one lower trust reputation tier

18. The system of claim 15, wherein the server computer is further configured to:
i) determine whether the quantity of undeliverable or unsolicited email is at least equal to a highest threshold quantity for the at least one lower trust reputation tier; and
ii) responsive to a determination that the quantity of undeliverable or unsolicited email is at least equal to the highest threshold quantity, defer transmission of the marketing campaign.

19. The system of claim 10, wherein the server computer is further configured to:
i) determine whether the first internet protocol address has been blocked from transmitting the marketing campaign; and
ii) responsive to a determination that the first internet protocol address has been blocked:
a) transmit the marketing campaign from the second internet protocol address;
b) identify at least one additional marketing campaign being sent from the first internet protocol address; and
c) transmit the at least one additional marketing campaign from a third internet protocol address.
